(19) United States
(12) Patent Application Publication
(10) Pub. No.: US 2012/0111674 A1
(43) Pub. Date: May 10, 2012

(54) WEAR-RESISTANT BRAKE DISC

(75) Inventor: Wayne-Ian Moore, CHANGHUA COUNTY (TW)

(73) Assignee: ASHIMA LTD., CHANGHUA COUNTY (TW)

(21) Appl. No.: 12/941,990

(22) Filed: Nov. 8, 2010

(51) Int. Cl. F16D 65/12

(52) U.S. Cl. 188/218 XL

(57) ABSTRACT

A wear-resistant brake disc includes a carrier-plate provided for adapting to assemble with a wheel hub and two outer rings respectively mounted on the two sides of the carrier-plate for providing a wear-resisting effect. The carrier-plate is composed of light metal. Each outer ring is composed of steel.

### BACKGROUND OF THE INVENTION

1. Field of the Invention

The present invention relates to a brake disc, and more particularly to a wear-resistant brake disc composed of two different materials for decreasing weight and providing wear resistance.

2. Description of Related Art

A conventional brake disc is utilized in a disk braking system. The conventional brake disc is usually formed with a single material, for example, aluminum or stainless steel. The aluminum provides a light-weighted effect. The stainless steel provides a highly strength and wear resistance.

However, the strength of the aluminum is not strong enough and is easily abraded. The stainless steel is too heavy to utilize on a light-weight bike.

The present invention has arisen to mitigate and/or obviate the disadvantages of the conventional brake disc.

### SUMMARY OF THE INVENTION

The main objective of the present invention is to provide an improved brake disc.

To achieve the objective, a wear-resistant brake disc in accordance with the present invention comprises a carrier-plate provided for adapting to assemble with a wheel hub and two outer rings respectively mounted on two sides of the carrier-plate for providing a wear-resisting effect. The carrier-plate is composed of light metal. The carrier-plate has a plurality of grooves annularly defined therein and passing therethrough such that each groove passes through the carrier-plate to respectively define two openings in two sides of the carrier-plate. Each outer ring is composed of steel. Each outer ring has a plurality of indentations defined in an outer side thereof. Each indentation has a bottom protruded from an inner side of each outer ring to form a protruding surface. The protruding surfaces of each outer ring are aligned with the grooves in the carrier-plate. The protruding surfaces of the outer ring are laterally inserted into the openings disposed in one side of the carrier-plate and the protruding surfaces of the other outer ring are inserted into the openings disposed in the other side of the carrier-plate. The two protruding surfaces in a same groove are connected by a fastening means such that the two outer rings are firmly connected with the carrier-plate. The fastening means is can be spot welding or thermal-adhesive bonding such that the two protruding surfaces in a corresponding groove are fixed to each other. The carrier-plate has two recesses respectively defined in the two sides thereof for respectively receiving the two outer rings. The carrier-plate has an axle hole centrally defined therein for adapting to assemble with the wheel hub. Each outer ring has a thickness less than or equal to a half thickness of the carrier-plate. Each outer ring has a plurality of vents defined therein and passing therethrough. Each vent is disposed between two adjacent indentations such that the vents and the indentations are alternately arranged on each outer ring.

In accordance with another aspect of the present invention, each outer ring has a plurality of protrusions extending therefrom and a plurality of vents defined therein and passing therethrough. The protrusions of each outer ring are aligned with the grooves in the carrier-plate and respectively located adjacent to the vents. The vents and the vents who asides the protrusions are alternatively arranged. Every two protrusions of each outer ring are respectively positioned on relative inner sides of the two vents and one vent located between the every two protrusions, and every two protrusions of each outer ring are respectively positioned on relative outer sides of the two vents and one vent located between the every two protrusions. The protrusions of one outer ring are laterally inserted into the openings disposed in one side of the carrier-plate and the protrusions of the other outer ring are inserted into the openings disposed in the other side of the carrier-plate. The two protrusions in a same groove are connected by a fastening means. The fastening means is spot welding or thermal-adhesive bonding.

Therefore, the wear-resistant brake disc in accordance with the present invention provides the following advantages:

1. The carrier-plate is composed of light metal and the thickness of the outer ring is decreased such that the weight of the brake disc is decreased. The material of the outer ring is steel such that a resistant strength of the brake disc is increased.

2. The outer ring is received in the recess in the carrier-plate and the protruding surfaces/protrusions of the outer ring are embedded into the groove in the carrier-plate. The two protruding surfaces/protrusions in the same groove are spot welded to each other. The two outer rings and the carrier-plate have a great contacting area disposed therebetween such that the two outer rings are firmly fixed/clamped on the two sides of the carrier-plate for transferring a braking shear load from outer rings to the carrier-plate. A resistant strength of the brake disc in accordance with the present invention is great to support a brake friction.

3. The fastening means for combining the two protruding surfaces is spot welding or thermal-adhesive bonding. The processing technology is simple. The manufacturing fee is decreased.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a wear-resistant brake disc in accordance with the present invention;

FIG. 2 is an assembled perspective view of the wear-resistant brake disc in accordance with the present invention;

FIG. 3 is a partial side plan view of the wear-resistant brake disc in accordance with the present invention in FIG. 2 in partial cross-section;

FIG. 4 is an exploded perspective view of a second embodiment of the wear-resistant brake disc in accordance with the present invention;

FIG. 5 is an assembled perspective view of the second embodiment of the wear-resistant brake disc in accordance with the present invention; and

FIG. 6 is a partial side plan view of the second embodiment of the wear-resistant brake disc in accordance with the present invention in FIG. 5 in partial cross-section.

### DETAILED DESCRIPTION OF THE INVENTION

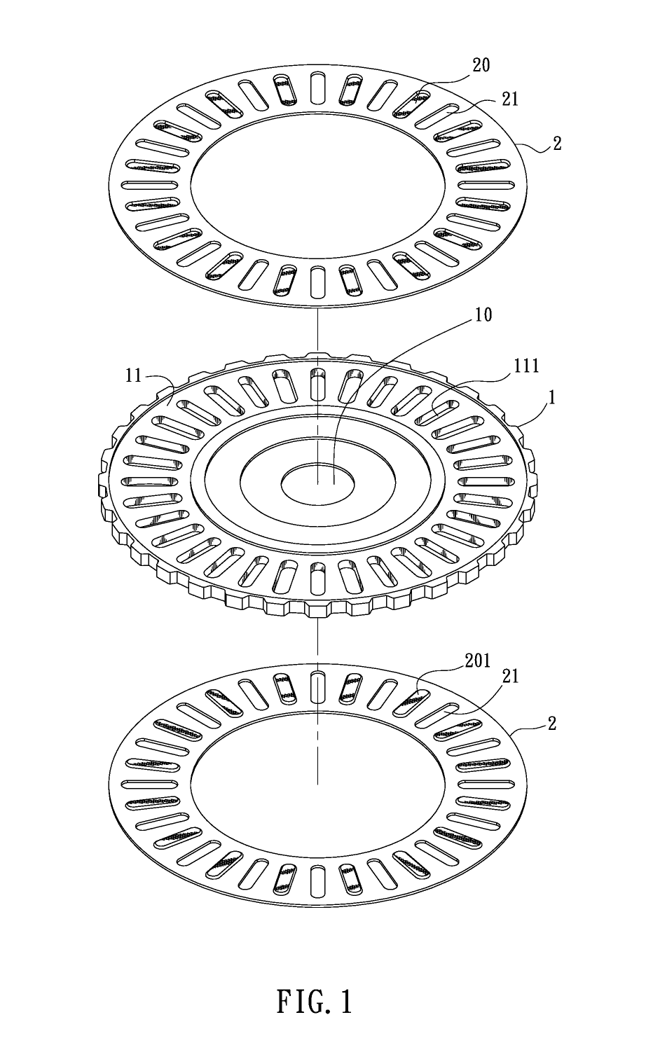

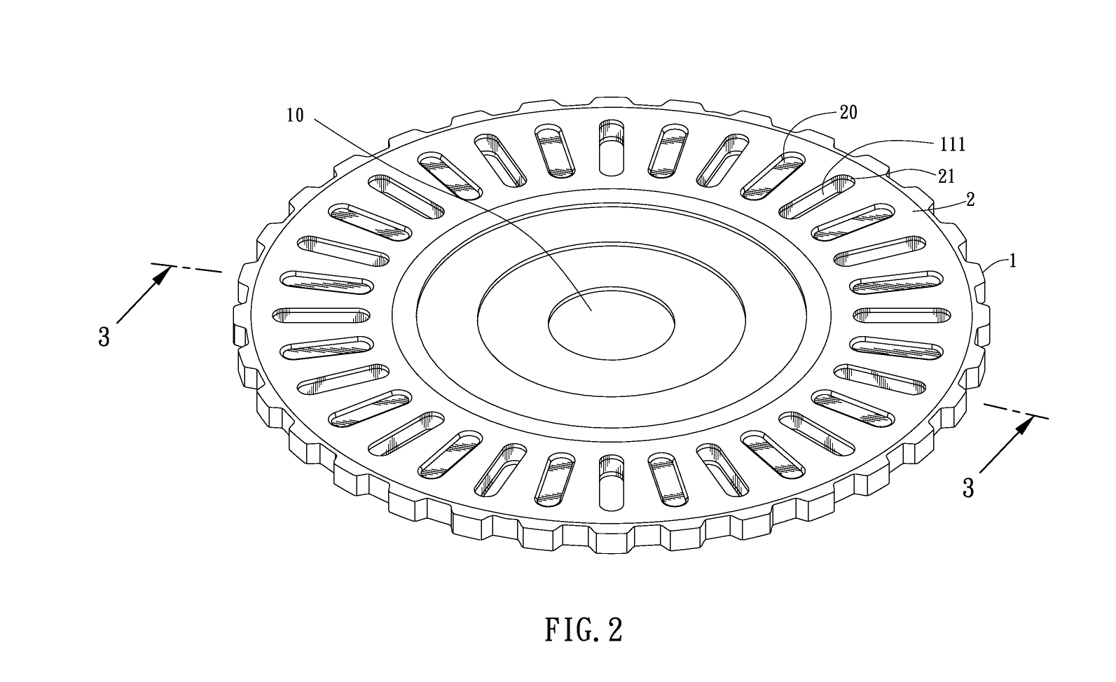

Referring to the drawings and initially to FIGS. 1-3, a wear-resistant brake disc in accordance with the present invention comprises a carrier-plate 1 provided for adapting to assemble with a wheel hub (not shown) and two outer rings 2 respectively mounted on two sides of the carrier-plate 1 for providing a wear-resisting effect.

The carrier-plate 1 is composed of light metal. In the preferred embodiment of the present invention, the light metal is aluminum. The carrier-plate 1 has an axle hole 10 centrally defined therein for adapting to assemble with a wheel hub. The carrier-plate 1 has two recesses 11 respectively defined in two sides thereof for correspondingly and respectively receiving the two outer rings 2. The carrier-plate 1 has a plurality of grooves 111 annularly defined therein and passing therethrough such that each groove 111 passes through the carrier-plate 1 to respectively define two openings (not numbered) in two sides of the carrier-plate 1.

Each outer ring 2 is composed of steel. In the preferred embodiment of the present invention, each outer ring 2 is composed of stainless steel or galvanized iron. Each outer ring 2 has a thickness less than or equal to a half thickness of the carrier-plate 1. Each outer ring 2 has a plurality of indentations 20 defined in an outer side (the side which is provided to contact with a disc brake) thereof. Each indentation 20 has a bottom protruded from an inner side (the side which is contacted with the carrier-plate 1) of each outer ring 2 to form a protruding surface 201. Each outer ring 2 has a plurality of vents 21 defined therein and passing therethrough for dissipating a braking heat. Each vent 21 is disposed between two adjacent indentations 20 such that the vents 21 and the indentations 20 are alternately arranged on each outer ring 2. The protruding surfaces 201 and the vents 21 of each outer ring 2 are correspondingly aligned with the grooves 111 in the carrier-plate 1. The protruding surfaces 201 of the outer ring 2 are laterally inserted into the openings disposed in one side of the carrier-plate 1 and the protruding surfaces 201 of the other outer ring 2 are inserted into the openings disposed in the other side of the carrier-plate 1.

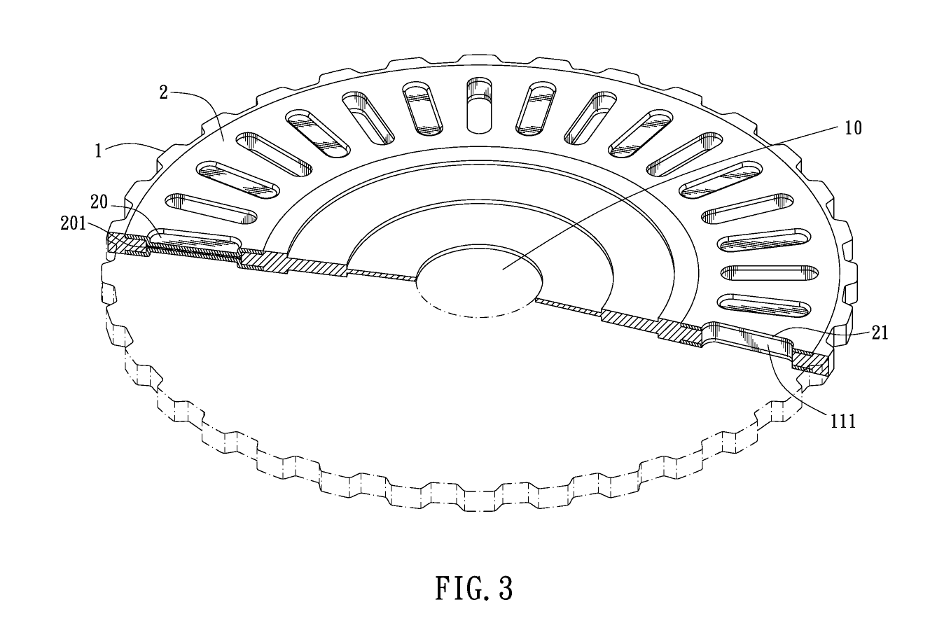

As shown in FIG. 3, the two protruding surfaces 201 in a same groove 111 are connected by a fastening means such that the two outer rings 2 are firmly connected with the carrier-plate 1 to form as a whole. In the preferred embodiment of the present invention, the fastening means can be spot welding or thermal-adhesive bonding such that the two protruding surfaces 201 in a corresponding groove 111 are fixed to each other for bonding the two outer rings 2 and the carrier-plate 1 together. Therefore, the two outer rings 2 are partially embedded into the carrier-plate 1. The two outer rings 2 and the carrier-plate 1 have a great contacting area disposed therebetween such that the two outer rings 2 are firmly fixed on the two sides of the carrier-plate 1 for transferring a braking shear load from outer rings 2 to the carrier-plate 1. A resistant strength of the brake disc in accordance with the present invention is great to support a brake friction.

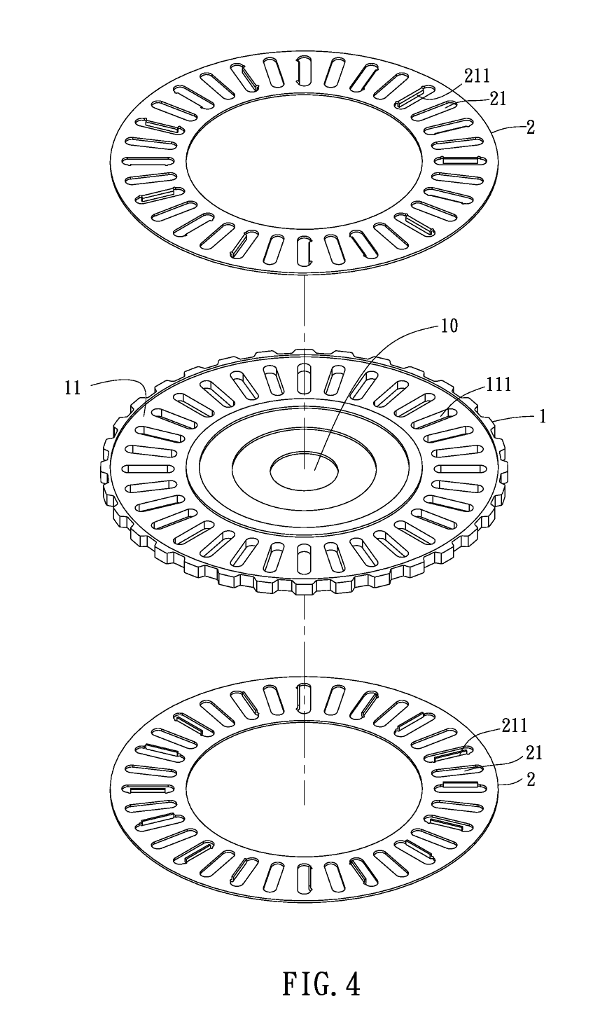

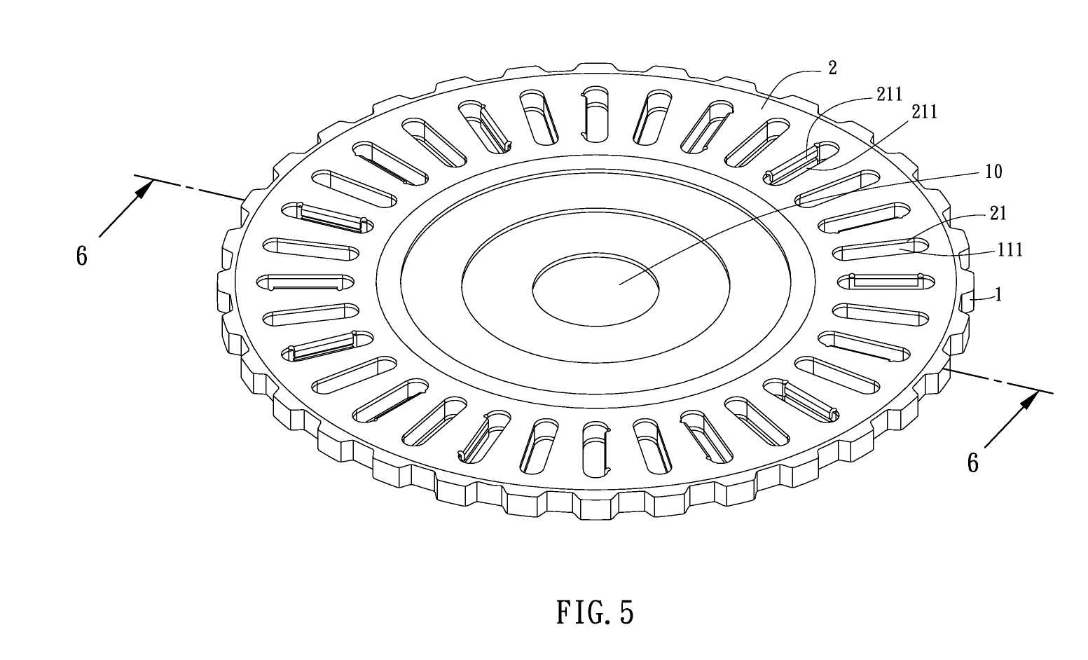

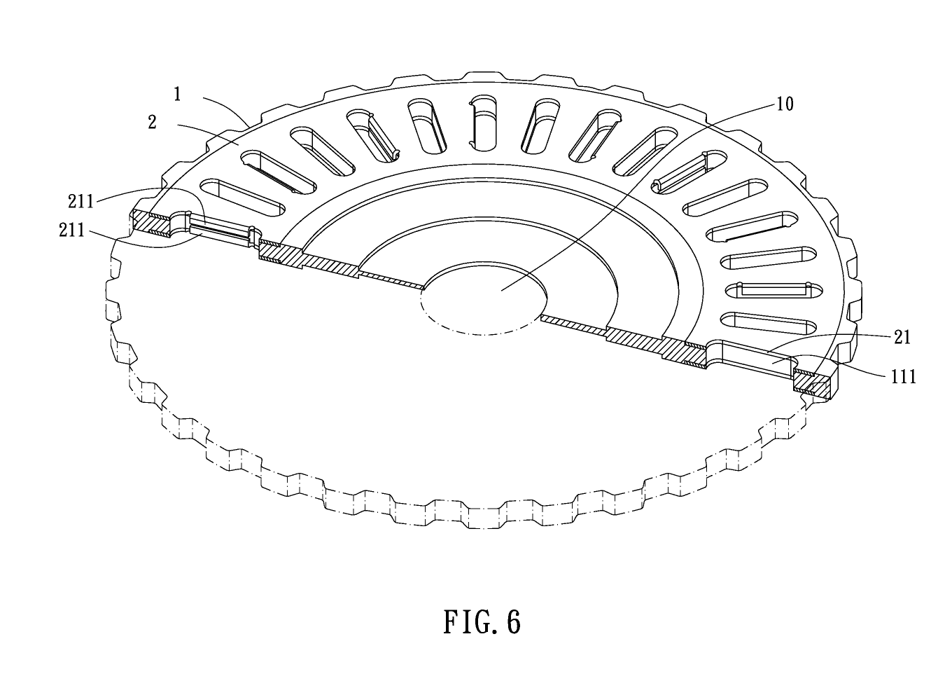

With reference to FIGS. 4-6, that shows a second embodiment of the wear-resistant brake disc in accordance with the present invention. The elements and effects of the second embodiment which are the same with the first embodiment are not described, only the differences are described. As shown in FIG. 4, the two outer rings 2 are respectively mounted on the two sides of the carrier-plate 1 for providing a wear-resisting effect. Each outer ring 2 has a plurality of protrusions 211 extending therefrom and a plurality of vents 21 defined therein and passing therethrough. The protrusions 211 of each outer ring 2 are respectively located adjacent to the vents 21 and respectively aligned with the grooves 111 in the carrier-plate 1. An amount of the protrusions 211 is less that of the vents 21. The vents 21 and the vents 21 who asides the protrusions 211 are alternatively arranged, therefore, every two protrusions 211 of each outer ring 2 are respectively positioned on relative inner sides of the two vents 21 and one vent 21 located between the every two protrusions 211, and every two protrusions 211 of each outer ring 2 are respectively positioned on relative outer sides of the two vents 21 and one vent 21 located between the every two protrusions 211. The protrusions 211 of one outer ring 2 are laterally inserted into the openings disposed in one side of the carrier-plate 1 and the protrusions 211 of the other outer ring 2 are inserted into the openings disposed in the other side of the carrier-plate 1. The two protrusions 211 in a same groove 111 are connected by a fastening means such that the two outer rings 2 are firmly clamped to the carrier-plate 1 for transferring a braking shear load from outer rings 2 to the carrier-plate 1. The fastening means is spot welding or thermal-adhesive bonding such that the two protrusions 211 in a corresponding groove 111 are fixed to each other for bonding the two outer rings 2 and the carrier-plate 1 together.

Although the invention has been explained in relation to its preferred embodiment, it is to be understood that many other possible modifications and variations can be made without departing from the spirit and scope of the invention as hereinafter claimed.

What is claimed is:

1. A wear-resistant brake disc comprising:
a carrier-plate provided for adapting to assemble with a wheel hub, the carrier-plate composed of light metal, the carrier-plate having a plurality of grooves annularly defined therein and passing therethrough such that each groove passes through the carrier-plate to respectively define two openings in two lateral sides of the carrier-plate;
two outer rings respectively mounted on the two sides of the carrier-plate for providing a wear-resisting effect, each outer ring composed of steel, each outer ring having a plurality of indentations defined in an outer side thereof, each indentation having a bottom protruded from an inner side of each outer ring to form a protruding surface, the protruding surfaces of each outer ring aligned with the grooves in the carrier-plate; and
wherein the protruding surfaces of the outer ring are laterally inserted into the openings disposed in one side of the carrier-plate and the protruding surfaces of the other outer ring are inserted into the openings disposed in the other side of the carrier-plate, the two protruding surfaces in a same groove are connected by a fastening means such that the two outer rings are firmly connected with the carrier-plate for transferring a braking shear load from outer rings to the carrier-plate.

2. The wear-resistant brake disc as claimed in claim 1, wherein the fastening means is spot welding such that the two protruding surfaces in a corresponding groove are fixed to each other for bonding the two outer rings and the carrier-plate together.

3. The wear-resistant brake disc as claimed in claim 1, wherein the fastening means is thermal-adhesive bonding such that the two protruding surfaces in a corresponding groove are fixed to each other for bonding the two outer rings and the carrier-plate together.

4. The wear-resistant brake disc as claimed in claim 1, wherein the carrier-plate has two recesses respectively defined in the two sides thereof for respectively receiving the two outer rings, the carrier-plate having an axle hole centrally defined therein for adapting to assemble with the wheel hub.

5. The wear-resistant brake disc as claimed in claim 1, wherein each outer ring has a thickness less than or equal to a half thickness of the carrier-plate.

6. The wear-resistant brake disc as claimed in claim 1, wherein each outer ring has a plurality of vents defined therein and passing therethrough, each vent disposed between two adjacent indentations such that the vents and the indentations are alternately arranged on each outer ring.

7. A wear-resistant brake disc comprising:
a carrier-plate provided for adapting to assemble with a wheel hub, the carrier-plate composed of light metal, the carrier-plate having a plurality of grooves annularly defined therein and passing therethrough such that each groove passes through the carrier-plate to respectively define two openings in two lateral sides of the carrier-plate;
two outer rings respectively mounted on the two sides of the carrier-plate for providing a wear-resisting effect, each outer ring composed of steel, each outer ring having a plurality of protrusions extending therefrom, the protrusions of each outer ring aligned with the grooves in the carrier-plate; and
wherein the protrusions of one outer ring are laterally inserted into the openings disposed in one side of the carrier-plate and the protrusions of the other outer ring are inserted into the openings disposed in the other side of the carrier-plate, the two protrusions in a same groove are connected by a fastening means such that the two outer rings are firmly clamped to the carrier-plate for transferring a braking shear load from outer rings to the carrier-plate.

8. The wear-resistant brake disc as claimed in claim 7, wherein the fastening means is spot welding such that the two protrusions in a corresponding groove are fixed to each other for bonding the two outer rings and the carrier-plate together.

9. The wear-resistant brake disc as claimed in claim 7, wherein the fastening means is thermal-adhesive bonding such that the two protrusions in a corresponding groove are fixed to each other for bonding the two outer rings and the carrier-plate together.

10. The wear-resistant brake disc as claimed in claim 7, wherein the carrier-plate has two recesses respectively defined in the two sides thereof for respectively receiving the two outer rings, the carrier-plate having an axle hole centrally defined therein for adapting to assemble with the wheel hub.

11. The wear-resistant brake disc as claimed in claim 7, wherein each outer ring has a thickness less than or equal to a half thickness of the carrier-plate.

12. The wear-resistant brake disc as claimed in claim 7, wherein each outer ring has a plurality of vents defined therein and passing therethrough, the protrusions of each outer ring respectively located adjacent to the vents.

13. The wear-resistant brake disc as claimed in claim 12, wherein every two protrusions of each outer ring are respectively positioned on relative inner sides of the two vents and one vent located between the every two protrusions.

14. The wear-resistant brake disc as claimed in claim 12, wherein every two protrusions of each ring are respectively positioned on relative outer sides of the two vents and one vent located between the every two protrusions.
